(19) United States
(12) Patent Application Publication
(10) Pub. No.: US 2012/0078809 A1
(43) Pub. Date: Mar. 29, 2012

(54) INTEGRATING SUB-PROCESSES IN BUSINESS PROCESS MODELING NOTATION PROCESSES

(75) Inventor: ROUVEN DAY, Waghaeusel (DE)

(73) Assignee: SAP AG, Walldorf (DE)

(21) Appl. No.: 12/891,493

(22) Filed: Sep. 27, 2010

(51) Int. Cl. G06Q 10/00

(52) U.S. Cl. 705/348

(57) ABSTRACT

This disclosure provides various embodiments for modeling a first business process as a sub-process of a second business process, the first business process less than fully compatible with a particular business process management system. The first business process is compatible with a first system adapted to execute the first business process. The first business process is identified and a user input received requesting modeling of the first business process as a sub-process of the second business process. A modeled sub-process is generated including a reference to the first system, callable from the modeled sub-process, and an interface definition defining an interface between the modeled sub-process and the first system. A modeled interface between a model of the second business process and the modeled sub-process is generated defining inputs and outputs between first and second business processes. In some aspects, the modeled sub-process can be deployed in a runtime environment.

### TECHNICAL FIELD

This disclosure relates generally to business process modeling, and more particularly to business workflow processes in business process modeling notation (BPMN) tools.

### BACKGROUND

Business Process Management (BPM) tools allow users to model, execute, and monitor your business processes based on a common process model. The Business Process Model and Notation (BPMN) is an industry standard graphic notation for representing business process workflows. BPMN shows the end-to-end flow of a business process in a flowchart-type style, and is often used with a user-interface-oriented BPMN tool. One example of a BPMN tool is SAP's NetWeaver BPM component (NW BPM, also referred to as “Galaxy”), which is designed to help users improve the efficiency of business processes, reduce errors in complex repetitive tasks, and lower exception-handling costs. With BPMN, users can compose process steps, define business rules and exceptions, model process flows using BPMN, execute process models efficiently, and support interaction with running processes via personalized user interfaces or interactive forms. Users can also monitor business processes to improve process quality and efficiency.

### SUMMARY

This disclosure provides various embodiments for modeling a first business process as a sub-process of a second business process using a particular business process management system, where the first business process is less than fully compatible with the particular business process management system. The first business process can be compatible with at least a first system adapted to execute the first business process. Modeling the first business process and a sub-process of the second business process can include identifying the first business process and receiving a user input requesting modeling of the first business process as a sub-process of the second business process. A modeled sub-process can be generated in response to the user request. The modeled sub-process can include a reference to the first system, callable from the modeled sub-process, and an interface definition defining an interface between the modeled sub-process and the first system. A modeled interface between a model of the second business process and the modeled sub-process can be generated that defines inputs from the second business process to the first business process and outputs from the first business process to the second business process.

In some aspects, the model of the second business process can include a reference to the modeled sub-process and be deployed in a runtime environment. Deploying the business process model can include identifying a reference to the modeled sub-process and the reference to the first system. The first business process can be invoked through a remote function call to the first system. Input data can be passed to the second system for use in executing the first business process, wherein the input data is passed through at least one interface adapted to translate data for use by the first system. Processed data can be received from the first business process through the at least one interface and used in the second business process.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example computing system including a business process modeling system.

FIG. 2 is a schematic illustration of an example system including a business process modeling system and business workflow platforms.

FIG. 3 is a flowchart illustrating an example computer process for modeling a business process including a noncompliant sub-process.

FIG. 4 is a flowchart illustrating another example of a computer process for a business process including a noncompliant sub-process.

FIG. 5 is a flowchart illustrating an example computer process for generating and deploying a business process model of a business process including a noncompliant sub-process.

FIGS. 6A-6E illustrate example screenshots of a user interface of a business process development tool.

Like reference symbols in the various drawings indicate like elements.

### DETAILED DESCRIPTION

This disclosure generally describes software, computer-implemented methods, and systems relating to a modeling tool adapted to integrate processes compatible with a first system with processes compatible with a second system, where the process of the first system is modeled as a sub-process of the process of the second system. As software modeling and development platforms evolve, some development components and software resources designed with, compatible with, or otherwise adapted for use with a first business process management environment may not be compatible with later-developed business process management environments, including products developed by third parties and newer versions of a previous process management environment. This can present a conundrum for business decision-makers and business software developers who desire to migrate to newer business process management environments but wish to retain use of processes that may become incompatible by virtue of the migration. The lifespan of a particular process, process definition, development component, or software resource (collectively “process,” or “development component”) within a particular organization may extend beyond the lifespan of the modeling or development tools used by the organization. Indeed, an organization may have built around, invested in, or otherwise committed itself to these newly “noncompliant” processes that are at least somewhat incompatible with the full feature set of a newly-adopted business process management platform. Accordingly, an organization may desire to retain the ability to model and deploy processes that are noncompliant on a new business process management platform, without having to redevelop the process for the new platform.

In some instances, particular modeling entities and platforms can be developed that can allow legacy, third-party, or other processes, not otherwise fully compatible with a particular business process management platform, to be modeled and used by the business process management platform. The modeling entity can include a callable reference to a pre-existing, noncompliant business process. The noncompliant business process can be modeled as a sub-process of “parent” processes and process events compatible with the business process management platform. The modeling entity for the noncompliant process can be integrated in the model of the parent process and deployed, as a package with the parent process model. Deployment of the parent business process model can result in the noncompliant process being invoked remotely, allowing the noncompliant process to be executed by compatible systems, while one or more interfaces allow the noncompliant process to interact with elements of the deployed parent process. Accordingly, use of the noncompliant business process can be retained despite migration to a business process management platform incompatible with the noncompliant business process.

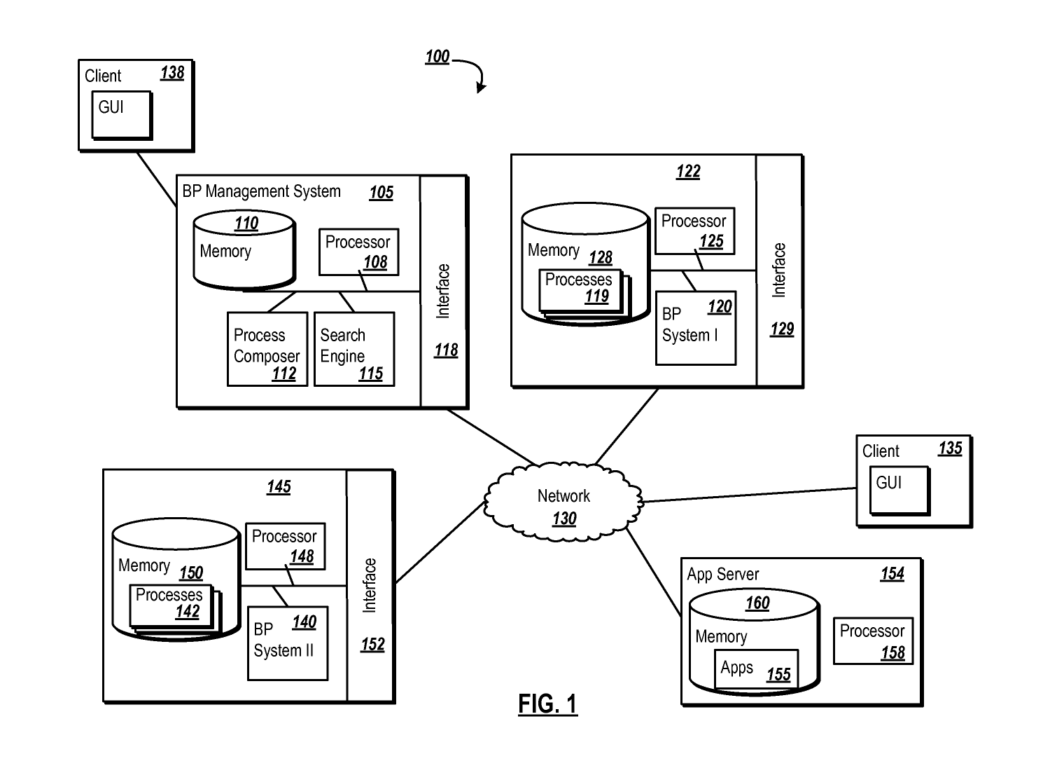

FIG. 1 illustrates an example computing system 100 including a business process management system 105 that includes a process composer modeling environment 112 and a search engine 115 for searching for process components for inclusion in a modeling session on the process composer 112. The business process management system 105 can be hosted on a computing device including at least one processor 108 and at least one memory device 110. The system 100 can further include at least one server 122 hosting a first business process environment 120. The first business process environment 120 can be compatible with and operate in connection with the business process management system 105. For instance, in some instances, the business process management system 105 can be a BPMN version 2.0 system and business processes 119 of the business process environment 120 can be BPMN version 2.0-compatible. The server 122 hosting the first business process environment 120 can include at least one processor device 125 and at least one memory device 128 that can store a plurality of business processes 119 adapted for use with the first business process environment 120.

One or more clients (e.g., 135, 138, 154) can access and interface with one or more of the business process management system 105 and business process environment 120 (as well as a second business process environment 140). Clients can include personal computing devices (e.g., 135, 138), application servers (e.g., 154), mainframe computing devices, and other client devices making use of business workflows, business processes, and business process models generated by the business process management system or business process environments 120, 140. Clients can be local to computing devices hosting business process management system 105 or business process environment 120 (e.g., 138), or remote clients (e.g., 135, 154) communicating with servers (e.g., 105, 122, 145) over one or more networks 130, such as a local area, private, enterprise, or public network, including the internet. Additionally, servers 105, 122, 145 can include one or more interfaces (e.g., 118, 129, 152) comprising logic encoded in software and/or hardware in a suitable combination and operable to communicate with a network 130, and other computing devices, including computing devices coupled to the network 130. More specifically, such interfaces can comprise software supporting one or more communication protocols associated with communications such that a network 130 or hardware is operable to communicate physical signals within and outside of the illustrated software environment 100.

In addition to the first business process environment 120, other business process environments and business processes can exist that are not immediately compatible with business process management system 105 or the first business process environment 120. For instance, a second business process environment 140, such as a legacy system or third-party system running a legacy BPMN version or another business process modeling standard, can be provided, including a plurality of business processes 142 compatible with the second business process environment 140. The second business process environment 140 and business processes 142 can be hosted on one or more computing devices, including servers (e.g., 145) that include at least one processor device 148 and one or more memory devices 150 storing business processes compatible with the second business process environment 140. Server 145 can also include one or more interfaces 152 adapted to communicate with other computing devices (e.g., 105, 122, 135, 138, 154) over a network 130. In some instances, the second business process environment 140 can be a legacy version of the first business process environment 120, and the first and second business process environments and business process management system 105 can be included in an enterprise software system and elements of each environment can be provided as services.

The business process management system 105 and business process environments 120, 140 can be implemented using one or more computing devices. As used in this document, the term “computing device” or “computer” is intended to encompass any suitable processing device. For example, a computing device can include one or more servers operable to receive, transmit, process, store, or manage data and information associated with the software environment 100. Additionally, computing devices implementing one or more of the business process management system 105 or business process environments 120, 140 can be implemented as a distributed or cloud-based computing environment. Additionally, the environment 100 may be implemented using computers other than servers, including a server pool. Further, any, all, or some of the servers (including computing devices 105, 122, 135, 138, 154) may be adapted to execute any operating system, including Linux, UNIX, Windows Server, or any other suitable operating system. Clients 135, 138, 154, as well as other users external to environment 100, can, directly or indirectly (e.g., via a proxy, virtual machine interface, etc.) access and perform operations, testing, and modeling using one or more of the business process management system 105 and business process environments 120, 140. It will be further understood that the term “application server” (e.g., 154) can include any suitable software component or module, or computing device(s) capable of hosting and/or serving a software application, including distributed, enterprise, or cloud-based software applications.

In some instances, computing devices, systems, processes, and applications in environment 100 can be hosted on a common computing system, server, or server pool, and share computing resources, including shared memory, processors, and interfaces with an enterprise software system or other software system. Computing devices in environment 100 can further interface with other software systems and client devices to communicate in a client-server or other distributed environment (including within environment 100).

Each of the example servers (e.g., 105, 122, 145, 154) illustrated can include a processor (e.g., 108, 125, 148, 158). Each processor can execute instructions and manipulate data to perform the operations of the associated server, and may comprise, for example, a central processing unit (CPU), a blade, an application specific integrated circuit (ASIC), or a field-programmable gate array (FPGA), among other suitable options. Processors can be implemented as one or more processors according to the particular needs of the associated server. References to a single processor can also be interpreted to include multiple processors where applicable. The operations that each processor executes can be determined by the purpose and operations of its associated server. Generally, the processor executes instructions and manipulates data to perform the operations of its respective server and, specifically, the software systems and applications (e.g., 155) hosted by the server.

At a high level, each “server” includes one or more electronic computing devices operable to receive, transmit, process, store, or manage data and information associated with the environment 100. Specifically, a server is responsible for receiving requests from one or more clients and sending the appropriate response to the requesting client. In addition to requests from external clients, requests may also be sent from internal users, external or third-party customers, other automated applications, as well as any other appropriate entities, individuals, systems, or computers. For example, although FIG. 1 illustrates single servers, a server can be implemented using one or more servers, as well as computers other than servers, including a server pool. Indeed, a server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, a server can be adapted to execute any operating system, including Linux, UNIX, Windows, Mac OS, or any other suitable operating system.

In the case of a server implementing business process management system 105, the server processor can execute the functionality required to receive and respond to requests and interactions from client devices 135, 138, as well as client applications 155 interfacing with the business process management system 105 and business process environments 120, 140. Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. Applications can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate.

At a high level, applications (e.g., 155) illustrated in the environment 100 can include any application, program, module, process, or other software that may execute, change, delete, generate, or otherwise manage information according to the present disclosure, particularly in response to and in connection with one or more requests received from the illustrated clients 135, 138, as well as other applications. In certain cases, only one hosted application may be located at a particular server. In others, a plurality of related and/or unrelated hosted applications may be stored at a single server, or located across a plurality of other servers, as well. In certain cases, environment 100 may implement a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed by remote clients 135, 138 or client applications 155 via the network 130 (e.g., through the Internet). Further, one or more processes associated with a particular hosted application may be stored, referenced, or executed remotely. For example, a portion of a particular hosted application may be a web service associated with the application that is remotely called, while another portion of the hosted application may be an interface object or agent bundled for processing at a remote client (e.g., 135). Moreover, any or all of the hosted applications may be a child or sub-module of another software module or enterprise application (not illustrated) without departing from the scope of this disclosure. Still further, portions of the hosted application may be executed by a user working directly at server hosting the application or remotely at a client computing device (e.g., 135).

Each of the example servers 105, 122, 145, 154 can also include a memory (110, 128, 150, 160, respectively). Each memory may include any memory or database module and may take the form of volatile or non-volatile memory including, without limitation, non-transitory memory elements, magnetic media, optical media, random access memory (RAM), read-only memory (ROM), removable media, or any other suitable local or remote memory component. Each memory may store various processes, process components, models, objects or data, including classes, frameworks, applications, backup data, business objects, jobs, web pages, web page templates, database tables, content repositories storing business or other dynamic information, or other information including any parameters, variables, algorithms, instructions, rules, constraints, or references thereto relevant to the purposes of the particular server. Each memory may also include any other appropriate data, such as VPN applications, firmware logs and policies, firewall policies, a security or access log, print or other reporting files, as well as others. Again, the particular data and instructions stored in each memory will be described in detail below in connection with the illustrated implementations of the software environment 100 and components thereof.

Generally, the network 130 facilitates wireless or wireline communications between the components of the software environment 100 (e.g., between the business process management system 105 and one or more business process environments 120, 140 and clients 135, 138, 154, as well as with any other local or remote computer, such as those associated with the one or more applications or external data sources. The network 130 can be implemented as one or more distinct networks. In any implementation, the network 130 may be a continuous or discontinuous network without departing from the scope of this disclosure, so long as at least a portion of the network 130 may facilitate communications between senders and recipients. The network 130 may be all or a portion of an enterprise or secured network. In some instances, a portion of the network 130 can be a virtual private network (VPN). All or a portion of the network 130 can comprise either a wireline or wireless link. Example wireless links may include 802.11a/b/g/n, 802.20, WiMax, and/or any other appropriate wireless link. In other words, the network 130 encompasses any internal or external network, networks, sub-network, or combination thereof operable to facilitate communications between various computing components inside and outside the illustrated environment 100. The network 130 may communicate, for example, Internet Protocol (IP) packets, Frame Relay frames, Asynchronous Transfer Mode (ATM) cells, voice, video, data, and other suitable information between network addresses. The network 130 may also include one or more local area networks (LANs), radio access networks (RANs), metropolitan area networks (MANs), wide area networks (WANs), all or a portion of the Internet, and/or any other communication system or systems at one or more locations.

The illustrated implementation of FIG. 1 includes one or more local and/or remote clients 135, 138. Each client 135, 138, 154 can be a computing device operable to connect or communicate at least with the business process management system 105, business process environments 120, 140, and/or the network 130 using a wireline or wireless connection. Each client 135, 138, 154 can include a graphical user interface (GUI). In general, each client 135, 138, 154 comprises an electronic computing device operable to receive, transmit, process, and store any appropriate data associated with the software environment of FIG. 1. It will be understood that there may be any number of clients 135, 138, 154 associated with environment 100, as well as any number of clients external to environment 100. Further, the term “client” and “user” may be used interchangeably as appropriate without departing from the scope of this disclosure. Moreover, while each client is described in terms of being used by one user, this disclosure contemplates that many users may use one computer or that one user may use multiple computers. As used in this disclosure, the client is intended to encompass a personal computer, touch screen terminal, workstation, network computer, kiosk, wireless data port, smart phone, personal data assistant (PDA), one or more processors within these or other devices, or any other suitable processing device. For example, a client (e.g., 135, 138) may comprise a computer that includes an input device, such as a keypad, touch screen, mouse, or other device that can accept information, and an output device that conveys information associated with operations of the business process management system 105, business process environments 120, 140, as well as other applications stored and/or executed on computing devices in the system 100, including application server 154 (or other servers in environment 100), or on the client 135, 136 itself, including digital data, visual information, or the GUI. Both the input device and the output device may include fixed or removable storage media such as a magnetic computer disk, CD-ROM, or other suitable media to both receive input from and provide output to users of the clients through the display, namely the GUI.

A GUI can comprise a graphical user interface operable to allow the user to interface with at least a portion of environment 100 for any suitable purpose, including allowing a user to interact with one or more software applications, including the business process management system 105 and business process environments 120, 140. Generally, a GUI provides users with an efficient and user-friendly presentation of data provided by or communicated within the system. The term “graphical user interface,” or GUI, may be used in the singular or in the plural to describe one or more graphical user interfaces and each of the displays of a particular graphical user interface. Therefore, the GUI can be any graphical user interface, such as a web browser, touch screen, or command line interface (CLI) that processes information in the environment 100 and efficiently presents the results to the user. In general, the GUI may include a plurality of user interface (UI) elements such as interactive fields, pull-down lists, media players, tables, graphics, virtual machine interfaces, buttons, etc. operable by the user at the client (e.g., 135, 138). These UI elements may be particularly related to and adapted for the functions of the business process management system 105 and business process environments 120, 140.

While FIG. 1 is described as containing or being associated with a plurality of elements, not all elements illustrated within environment 100 of FIG. 1 may be utilized in each alternative implementation of the present disclosure. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

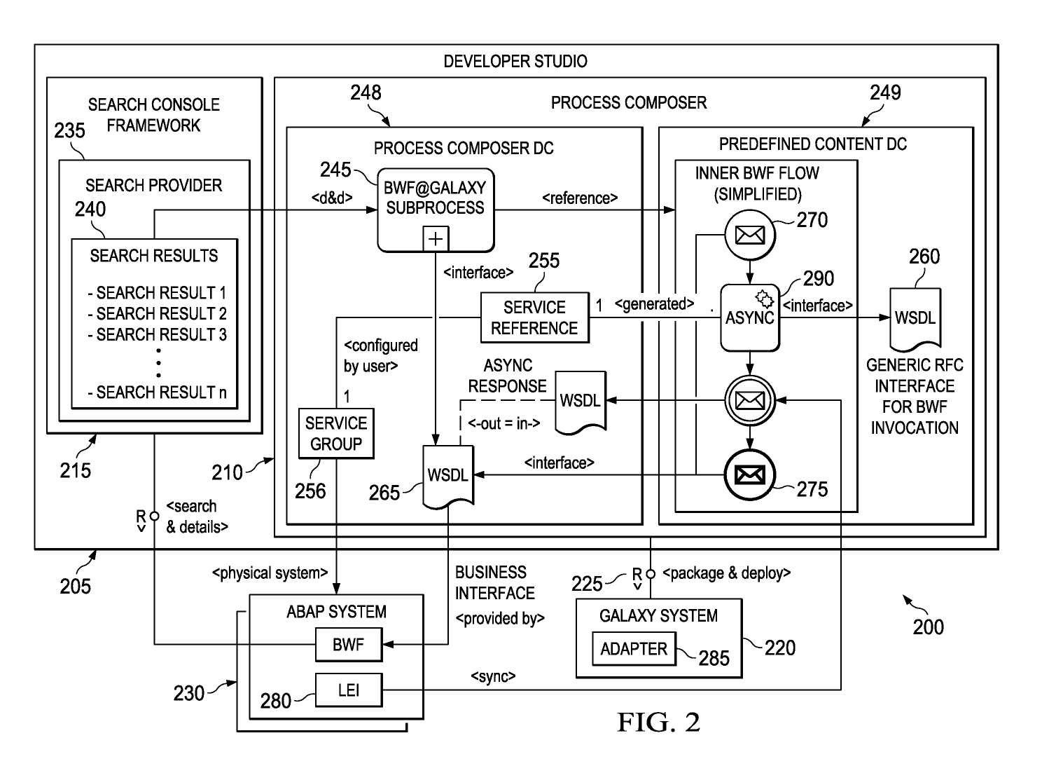

FIG. 2 is a schematic representation of one example implementation of a business process management system 200, for instance, a business process modeling notation (BPMN) system. The system 200 can include a development environment 205 that includes a process composer 210 and a search framework 215. Further, a first business process environment 220 can be provided that can accept packaged development components 248 and 249 for deployment 225 and execute the processes modeled in the process composer 210 through, for example, one or more remote function call (RFCs) (e.g., 260). The business process modeling language, version, standard, or format can vary between different business process management systems, vendors, and business process environments.

In some instances, different business process management systems and business process modeling (BPM) tools adopting various BPM formats, can be incompatible with each other. In other words, models and processes compatible with a particular business process environment (e.g., 230) may not be compatible with other business process environments and BPM tools. In some instances, a process or process component, is in some measure incompatible (or “noncompliant”) with a particular BPM format when the process cannot be accessed, modified, deployed or executed in accordance with the full feature set of business process environments and tools compatible with the BPM format. This can cause some difficulty during migration from one BPM system to another, as some users may be reliant on a third-party or legacy processes that have become incompatible with a new business process system. To remedy this, as well as provide other advantages, a business process management system 200 can be adapted to search, model, deploy, and run noncompliant processes in connection with a business process environment 220. Additionally, in some instances, a search framework 215 can be used that includes a search provider 235 adapted to search, and return search results sets 240 that include noncompliant processes for inclusion in the model. The search results 240 can be returned in response to a query that includes certain search terms, tags, criteria or metadata. The user can then select one or more noncompliant processes from the set of search results for modeling in the business process management system 200 and later, deployment and execution on business process environment 220. In other instances, rather than identifying a particular process from a set of search results, a user can specifically identify (e.g., by name) a particular pre-existing process, process component, or process definition and select the process for modeling. The process selected for modeling can be designated as a sub-process, or child, of a parent process compatible with the BPM format of the business process management system 200. The parent process is stored in a development component 248 and references a development component 249 which contains the generic model for integrating noncompliant processes into the process flow of the parent process.

In some instances, development components 248, 249 can be compiled, deployed, and executed on systems compatible with the particular format of the development component and/or processes defined in the development component. In the example of FIG. 2, a process corresponding to development component 249 (as well as development component 248) can be less than fully compatible with a particular business process environment 220. In order to deploy a particular model that includes both compatible processes as well as references to a noncompliant sub-process, development component 249 can be provided, containing the generic model for integrating noncompliant processes and deploying them on business process environment 220. Indeed, the development component 249 can specifically identify that the modeled process corresponding to the development component 249 is a non-compliant process and that the process is to be modeled as integrated with a parent process as a sub-process.

Development component 248 can include an integrated sub-process reference 245 referencing a second development component 249 modeling the sub-process. The sub-process reference 245, in some instances, can further indicate that the sub-process is noncompliant with the business process environment. Additionally, parent development component 248 can further include service reference 255, service group 256, and one or more business interfaces 265. In other instances, the service reference 255, as well as service group 256 entities can be included in or shared with the development component 249 modeling the sub-process. For instance, in some implementations, the service reference 255 and service group can be identified by an automated activity 290. Additionally, the modeled business interfaces 265 between two development components (e.g., 248, 249) can be considered shared between the development components 248, 249 The service reference 255 can indicate that the business process is noncompliant with the business process environment and needs to be invoked and executed on its own platform during execution of the model of the parent process. For instance, when the development component of the parent process is deployed, the development component 248 of the sub-process can be identified, together with the service reference 255, resulting in a remote function call 260 to invoke and run the noncompliant business process on the server hosting the noncompliant business process. The service group resource 256 can identify the physical system on which the remote sub-process should be invoked through the remote function call interface 260. The business interface 265 can identify the inputs needed for the noncompliant sub-process, as well as the anticipated outputs, that will be exchanged with events, activities, and other sub-processes of the parent process. The interface 265 can correspond with start 270 and/or end 275 events of the noncompliant process. In other words, the modeled interface 265, generally, can define and specify the “contract” between the two development components 248, 249 modeling the respective parent- and sub-processes.

A specialized development component 249 can be generated for modeling noncompliant business processes designated as sub-processes of a compliant business process modeled by a development component 248. The noncompliant process can be a preexisting process, including preexisting processes of a legacy system. The development component 249 of the noncompliant sub-process can include data specifying one or more events of the corresponding non-compliant sub-process. The development component 249 of the noncompliant sub-process can further include an automated activity 290 that can be used to trigger a call to a real world environment 230 adapted to execute the noncompliant process. The automated activity 290 can be further used to define the specifications for an interface 260 between the modeling environment or development component 249 and a real world environment 230 adapted to execute the noncompliant process. For instance, the data exchanged between the parent process modeled by development component 248 and the start 270 and end 275 events of a noncompliant sub-process modeled by development component 249 can be passed to the real world system over interface 260 defined in the sub-process development component 249. As an example, the modeled interface 265 can require a certain set of input data to be passed from a compliant parent process to a start event 270 of the sub-process. This can be defined by modeled interface 265. In some instances, the format or structure of the data passed by the compliant parent process will need to be translated for use in the sub-process executed on system 230. The interface 260 can be defined to translate the data transmitted from the parent process for use by system 230. Additionally, the interface 260 can further translate data returned by the executed noncompliant sub-process on system 230 for use on the systems executing the parent process modeled by development component 248. In some instances, interface 260 can be a generic RFC interface implemented using WSDL.

Outputs generated by the noncompliant process, running on business process environment 230, can be facilitated through a local event infrastructure 280 included in a system 230 adapted to execute the noncompliant process modeled by development component 249. The system 230, in some instances, can be a legacy business process environment, third-party business process environment, or other business process environment. Additionally, one or more adapters 285 can be provided on the compliant business process environment 220 to perform any needed translations on data returned from the noncompliant sub-process for use by other events in the parent process. After the noncompliant process has been executed successfully, the noncompliant process sends its results back to a typed message event definition of an intermediate catch event (exposed as a process end point), that corresponds to the location in the parent process interacting with the sub-process.

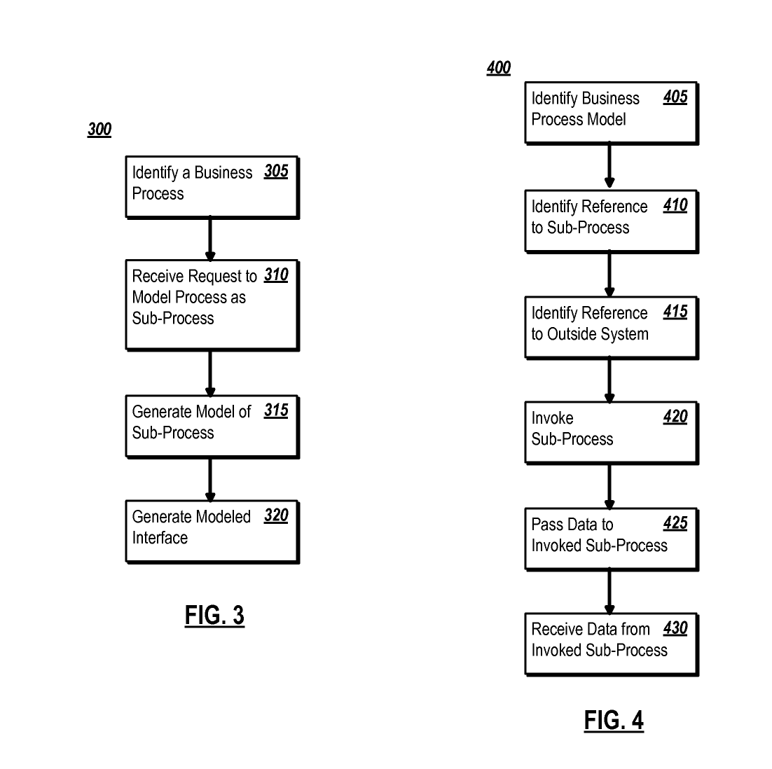

FIG. 3 is a flowchart 300 illustrating an example computer process for modeling a business process. At least one first business process can be identified 305 from a plurality of business processes compatible with a first system. The first process can be less than fully compatible with a particular business process management system modeling at least one second business process compatible with the particular business process management system. The first business process can include a preexisting process, or developing a new process, either from scratch, by combining other preexisting software components, or by modifying a preexisting process. A user input can be received 310 requesting modeling of the first business process as a sub-process of the second business process. A modeled sub-process can be generated 315 that models the first process as a sub-process of the second business process. The modeled sub-process can include data defining a process flow corresponding to the modeled first process, the process flow including at least a start event and an end event. The modeled sub-process can further include a reference to the first process, callable from the modeled sub-process, to the first system. Further, the modeled sub-process can include an interface definition defining an interface between the modeled sub-process and the first system, adapted to allow data to be translated and passed between the modeled sub-process and the first system adapted to execute the first business process. Modeling the sub-process can further include generating 320 a modeled interface between a model of the second business process and the modeled sub-process, the interface defining inputs from the second business process to the first business process and outputs from the first business process to the second business process. For instance, the modeled interface can model an inbound interface adapted to pass input data to the first business process from the second business process and an outbound interface between the first and second business processes, adapted to pass processed data from the first business process to the second business process. The inbound interface can correspond with a start event and the outbound interface with an end event of the modeled sub-process. Additionally, in some instances, the inbound interface can be the in-message of a business interface and the outbound interface the out-message of the same business interface.

The compliant business process can be modeled 315 so as to present to a user business-relevant events included in the compliant business process, such as those events included in the process flow of the modeled sub-process. A business workflow model can be adapted to illustrate the process's definition and functionality in a manner adapted for business users, including users more interested in and conversant in the business aspect and application of the process. Other workflow models, such as development workflow models, adapted for technical, software developer users, can also be generated and presented to users based on the process definition of the compliant business process. Events in the non-compliant process can also be modeled 315, integrated, and presented with the compliant process as a sub-process of the compliant process, or an event or activity in the compliant process. For instance, a user can substitute an event of a compliant process, defining a particular set of operations, with a sub-process comprising a noncompliant process. In some instances, a plurality of events can also be identified in the non-compliant process, including business relevant events. The events of the non-compliant process can also be presented to the user in a GUI display of the modeled non-compliant process.

In some instances, generating a model of a process, as well as integrating a noncompliant sub-process within a compliant process, can be based on further user inputs. For instance, in response to a user request to integrate a sub-process into a parent process model, the user can be prompted to define certain aspects of the interface between the parent process and sub-process, as well as define dependencies between the processes. In other instances, interface attributes and process dependencies can be identified and defined automatically.

In some instances, a modeled business process workflow, including models that include an integrated, non-compliant sub-process (such as described in connection with FIG. 3), can be deployed in a runtime environment. For instance, as illustrated in the flowchart 400 of FIG. 4, a business process model can be identified 405 that models a first business process. The first business process can include at least one sub-process and be compatible with a first business process management system. The sub-process can also be modeled in the business process model and correspond to at least one second business process that is less than fully compatible with the first business process management system. The second business process can be executable on a second business process system. The identified business process model can be deployed in a runtime environment. Deployment of the model can include identifying 410 a reference to the particular business process associated with the sub-process. In some instances, deployment can continue by identifying 415 a reference identifying the location or system where the particular business process is hosted or with which the second business process is compatible. The second business process can be invoked 420 through a remote function call to the identified second system. The particular business process can be invoked on remote or local computer systems communicatively coupled to the system deploying the business process model. Additionally, input data can be passed 425 to the second system for use in executing the second business process through at least one interface adapted to translate data for use by the second system. Likewise, processed data can be received 430 from the second business process and used by the first business process compliant with the first business process management system.

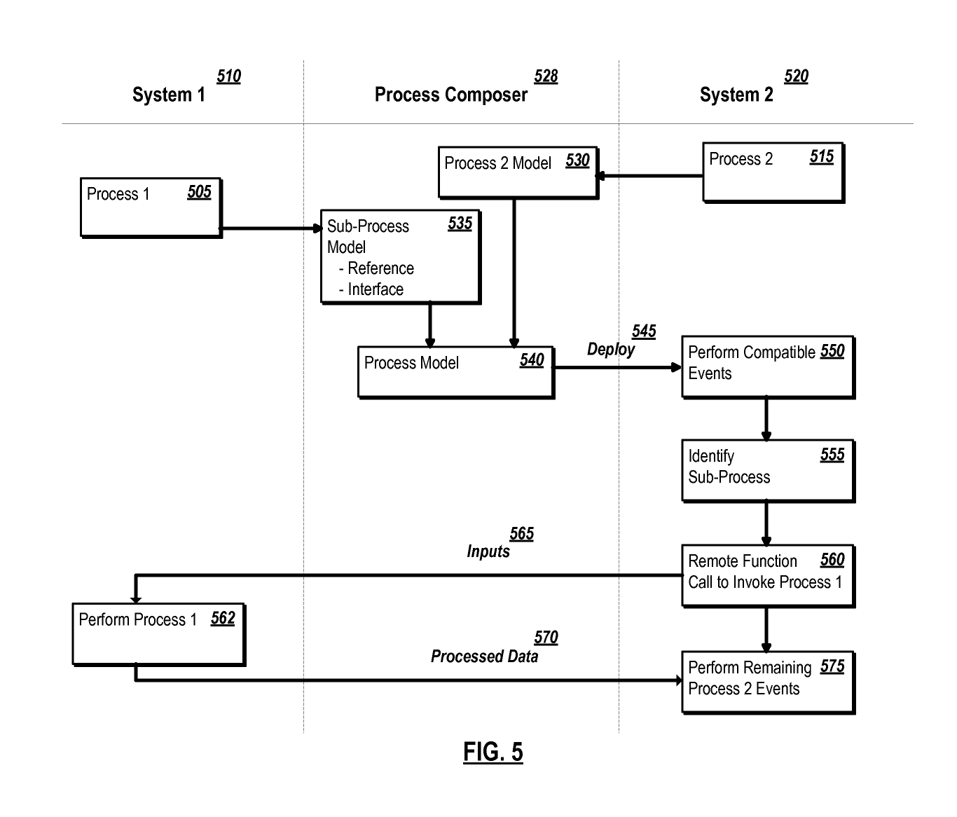

FIG. 5 is another flow diagram 500 illustrating the modeling and deployment of a business process that includes an integrated, non-compliant sub-process. To integrate a non-compliant sub-process 505 compatible with a first business process platform 510 into a parent process 515 compatible with a second business process platform 520, a process composer 528 can be used. The process composer 528 can create a deployable business process model 530 of the parent process 515. Additionally, a business process model 535 can be generated, by the process composer 528, that is adapted for integrating other processes, at least partially incompatible with the second business process platform 520, as sub-processes of a parent process. In this case, the first business process 505 is not fully compatible with the second business process platform 520, but is modeled as a sub-process of parent process 515. The business process modeling entity 535 can include a reference to the sub-process, in this case the first business process 505, as well as the system 510 hosting, serving, executing, deploying, or otherwise associated with the first business process 505. The modeling entity 535 can further specify one or more interfaces for exchanging data between events in the parent process 515 and the sub-process during deployment of the modeled parent process. The modeling entities 530, 535 for the parent process 515 and sub-process 505, respectively, can be combined into a single modeling entity 540 or deployment package adapted for deployment on a particular system. In this example, modeling entity 540 is deployable on the second business process system 520, while in other instances, processes of the second system 520 can be sub-processes of processes in the first system 510 and a corresponding modeling entity can be generated for deployment on the first system 510.

Continuing with the example of FIG. 5, the modeling entity 540 can be deployed 545 on the second system 520. Processes, events, and activities that are compliant with, compatible with, executable on, or local to the second system can be deployed, executed, and compiled 550 by the second system 520. As deployment of the parent process progresses according to modeling entity 540, a sub-process 505 of the parent process 515 can be identified 555, together with the corresponding elements of the modeling entity 540. A remote function call 560 can be made, based on the reference to the first process 505 and first system 510 to invoke the first process 505. Given that the first process 505 is incompatible with the second system, operations, events, and activities performed by the first process can be carried out 562 on a system (i.e., 510) compatible with the process 505. Inputs for use by the first process (sub-process) 505 can be provided 565 to the first process 505 via the interface defined in the sub-process's model 535. Any data that results from the first process that is to be used by remaining steps (or other sub-processes) in the parent process 515 can be returned 570, through a defined interface. Remaining events in the parent process 515 can then be executed 575.

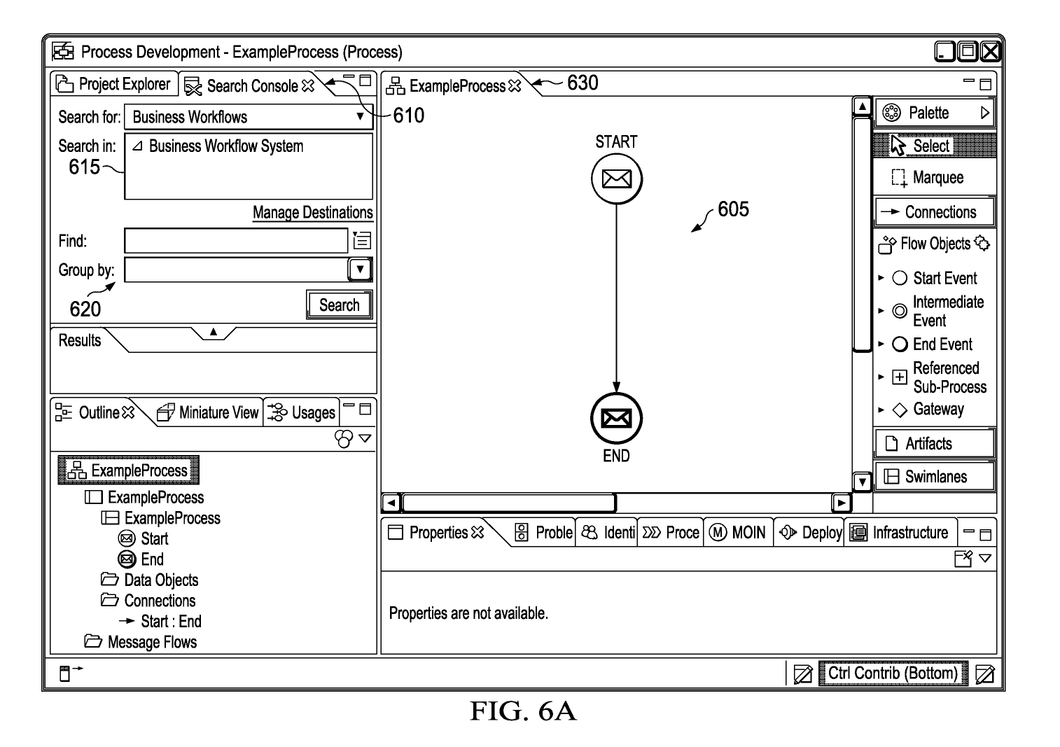

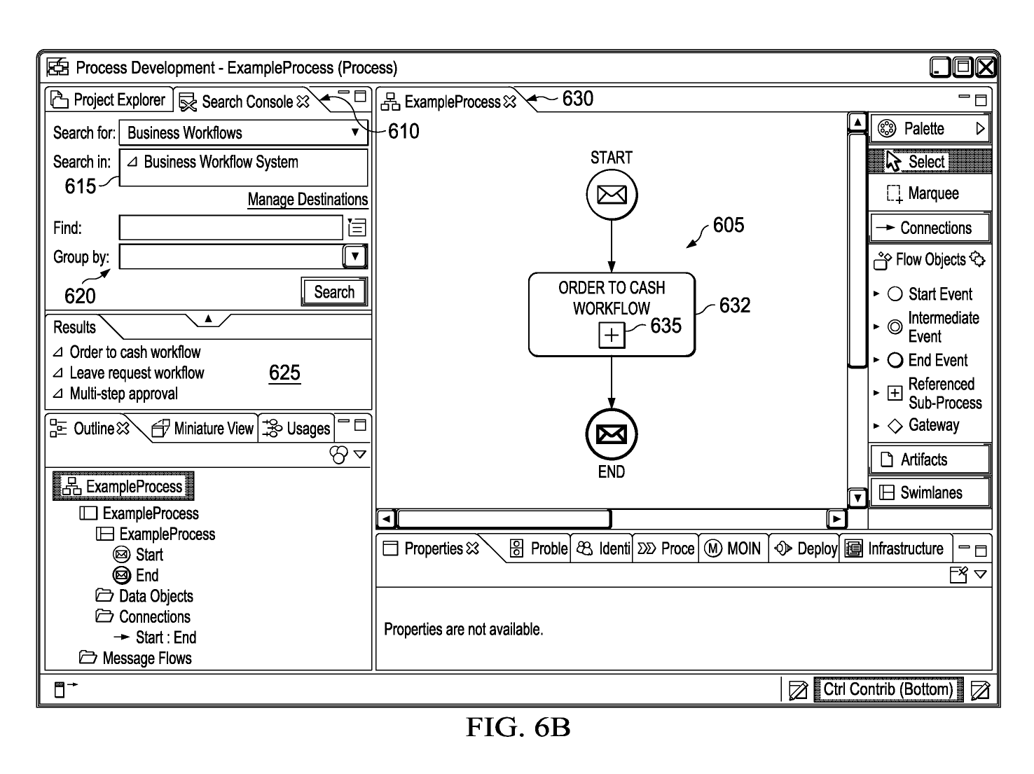

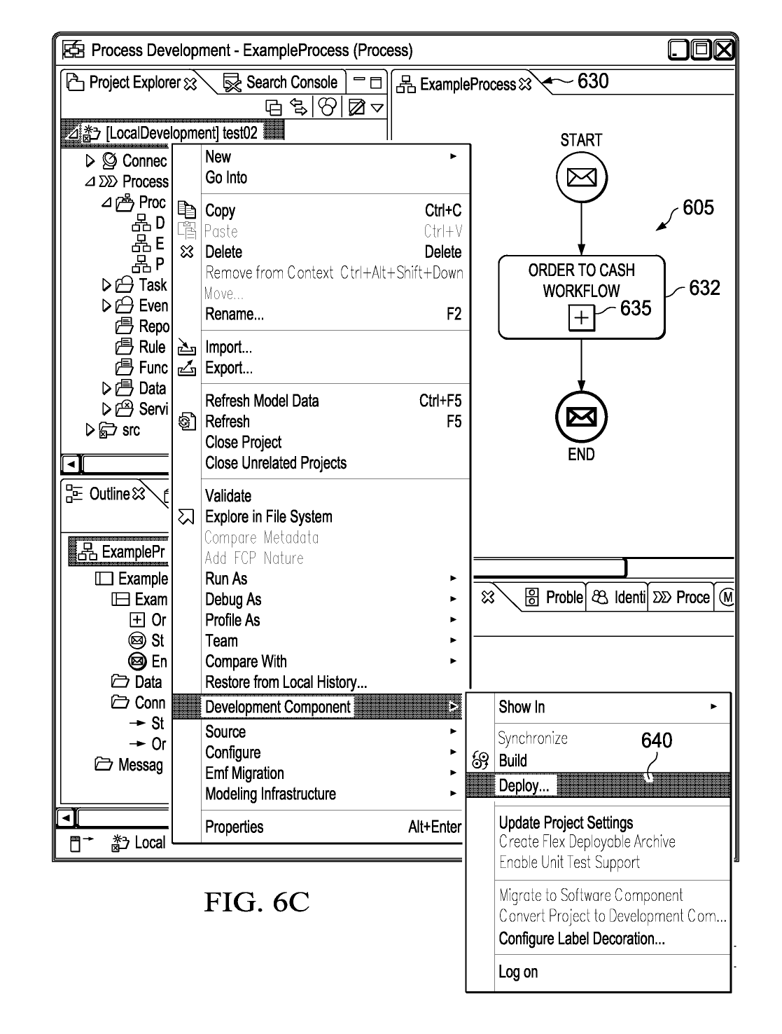

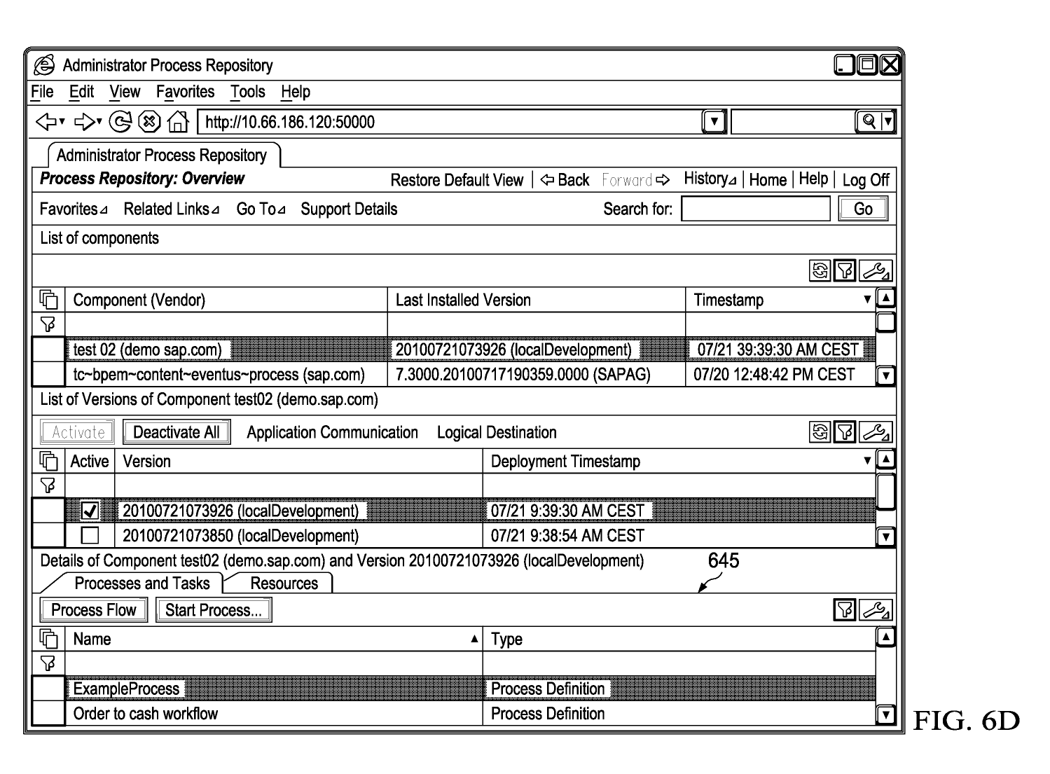

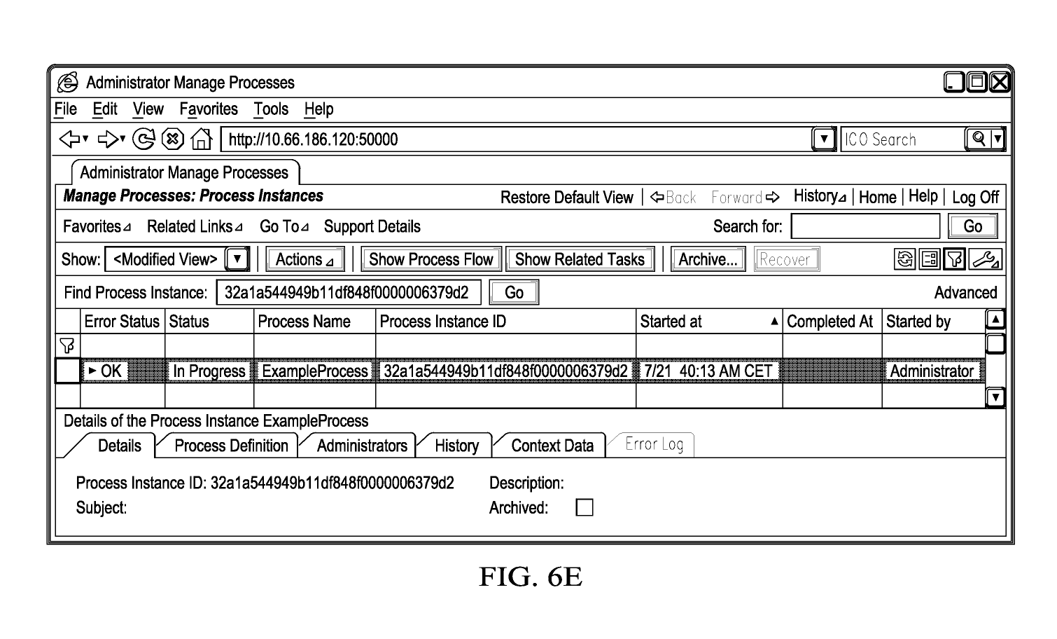

FIGS. 6A-6E show example screenshots of a graphical user interface (GUI) used in connection with the modeling and deployment of a business process that includes an integrated, non-compliant sub-process. FIG. 6A shows a screenshot of a GUI for building business process models. For instance, in this simplified example, a rudimentary business process model 605 is being constructed that can be later deployed as a business process on a particular business process platform. A search console 610 can be provided allowing a user to select reusable process components for inclusion or integration in the modeled process 605. In some instances, process component sources can be selected 615 that include processes that are not fully compatible with the particular business process platform. Additionally, one or more search prompts 620 can be provided that allow the user to specify certain search criteria for finding one or more process components for inclusion in the modeled process 605.

FIG. 6B shows a set of search results 625 that have been returned for a particular search of a source of non-compliant processes. As shown in the model development workspace 630, one of the returned processes, entitled “Order to cash workflow,” in the set of search results 625 has been selected for inclusion in the modeled process 605 as a sub-process 632 of the process 605. The graphical representation of sub-process 632 can be distinguished from other events or activities in the modeled process 605. In this instance, an icon 635 can be included on the sub-process 632, indicating that the process is a sub-process and that more details can be viewed regarding the sub-process, such as events, interfaces, and references relating to the sub-process.

With the simplified parent process modeled to include sub-process 632, the modeled parent process can be deployed. In some instances, as shown in FIG. 6C, deployment of the modeled process 605 can be initiated 640 from the process composer itself. As shown in FIG. 6D, components 645 included in the modeled process can be presented to the user, before or in response to initiating deployment of the modeled process. Deployment of the model can proceed by invoking a remote, noncompliant sub-process according to the techniques described above, such as in connection with FIGS. 4 and 5. As shown in FIG. 6E, the user can monitor progression of the modeled process. In some instances, the user of the business process model can remain unaware that an outside system is used to deploy and execute portion of the modeled process (in this case the noncompliant sub-process). To the user, the process, including noncompliant sub-processes, appear to execute seamlessly, all on the same system. This can be advantageous, as the source of a particular sub-process can be unimportant to the user, as compared to the ultimate functionality desired and provided through the selected sub-process.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Other variations are within the scope of the following claims.

What is claimed is:

1. A computer-implemented method for modeling a business process, the method comprising:
identifying at least one first business process from a plurality of business processes compatible with at least a first system, the first process less than fully compatible with a particular business process management system modeling at least one second business process compatible with the particular business process management system;
receiving a user input requesting modeling of the first business process as a sub-process of the second business process;
generating a modeled sub-process modeling the first process as a sub-process of the second business process, the modeled sub-process including:
a reference, callable from the modeled sub-process, to the first system; and
an interface definition defining an interface between the modeled sub-process and the first system; and
generating a modeled interface between a model of the second business process and the modeled sub-process, the interface defining inputs from the second business process to the first business process and outputs from the first business process to the second business process.

2. The method of claim 1, wherein the generated modeled sub-process further includes a process flow including at least a start event and an end event.

3. The method of claim 2, wherein the inputs correspond to the start event and the outputs correspond to the end event.

4. The method of claim 2, wherein events in the process flow correspond to events in the first business process.

5. The method of claim 1, wherein modeling of the second business process includes presenting a graphical representation of a model to a user.

6. The method of claim 5, wherein the modeled sub-process is integrated in the model.

7. The method of claim 6, further comprising deploying the model in a runtime environment.

8. The method of claim 5, wherein the model comprises a business process modeling notation (BPMN) model.

9. The method of claim 1, wherein the modeled sub-process further includes an asynchronous event adapted, when executed, to:
request the first system to execute the first business process; and
translate input data from the second process for use by the first system in executing the first business process; and
translate output data returned by the executed first business process for use by the second business process.

10. The method of claim 9, wherein the asynchronous event further identifies the callable reference.

11. The method of claim 1, wherein the first business process is a legacy process and the first system is a legacy version of the particular business process management system.

12. The method of claim 1, wherein the first business process is associated with a third-party source.

13. The method of claim 1, further comprising receiving a search query from a user to search a plurality of processes including the plurality of processes compatible with the first system, wherein identifying the first business process includes providing a set of search results to the user based at least on the search query, the set including the first business process.

14. The method of claim 1, wherein the first business process is identified in response to a user request for the first business process.

15. The method of claim 1, wherein generating the modeled sub-process includes generating an intermediate catch event in a model of the first process pointing to an asynchronous operation to be called by the first system.

16. The method of claim 1, further comprising receiving dependency data specifying at least one dependency between the first process and the second process.

17. The method of claim 16, further comprising prompting a user for dependency data in response to the user input requesting modeling of the first business process, wherein the received dependency data is received from the user.

18. A computer-implemented method for deploying a modeled business process, the method comprising:
identifying a business process model modeling a first business process, the first business process compatible with a particular business process management system and including at least one sub-process, wherein the sub-process modeled in the business process model corresponds to at least one second business process less than fully compatible with the particular business process management system and capable of execution on at least one second system; and
deploying the business process model in a runtime environment, wherein deploying the business process model includes:
identifying a reference to the second system;
invoking the second business process through a remote function call to the second system;
passing input data to the second system for use in executing the second business process, wherein the input data is passed through at least one interface adapted to translate data fro use by the second system;
receiving processed data from the second business process through the at least one interface; and
using the processed data in the first business process.

19. The method of claim 18, wherein the particular business process is hosted by at least one remote server, wherein data is passed to and processed data received from the remote server.

20. The method of claim 18, wherein the business process model defines a modeled interface between the first business process and the second business process, the modeled interface defining inputs to the second business process from the first business process and outputs from the second business process to the first business process.

21. The method of claim 20, wherein inputs to the second business process corresponding to a start event of the second business process and outputs from the second business process correspond to an end event of the second business process.

22. The method of claim 18 wherein the at least one interface is further adapted to translate processed data for use by the first business process.

23. The method of claim 18, wherein the modeled sub-process includes:
at least one intermediate event identifying the reference to the second business process, wherein the reference is callable through the remote function call, and defining the at least one interface.

24. The method of claim 18, wherein the business process model is a business process modeling notation (BPMN) model.

25. An article comprising a non-transitory, machine-readable storage device storing instructions operable to cause at least one processor to perform operations comprising:
identifying at least one first business process from a plurality of business processes compatible with at least a first system, the first process less than fully compatible with a particular business process management system modeling at least one second business process compatible with the particular business process management system;
receiving a user input requesting modeling of the first business process as a sub-process of the second business process;
generating a modeled sub-process modeling the first process as a sub-process of the second business process, the modeled sub-process including:
a reference, callable from the modeled sub-process, to the first system; and
an interface definition defining an interface between the modeled sub-process and the first system; and
generating a modeled interface between a model of the second business process and the modeled sub-process, the interface defining inputs from the second business process to the first business process and outputs from the first business process to the second business process.

26. An article comprising a non-transitory, machine-readable storage device storing instructions operable to cause at least one processor to perform operations comprising:
identifying a business process model modeling a first business process, the first business process compatible with a particular business process management system and including at least one sub-process, wherein the sub-process modeled in the business process model corresponds to at least one second business process less than fully compatible with the particular business process management system and capable of execution on at least one second system; and
deploying the business process model in a runtime environment, wherein deploying the business process model includes:
identifying a reference to the second system;
invoking the second business process through a remote function call to the second system;
passing input data to the second system for use in executing the second business process, wherein the input data is passed through at least one interface adapted to translate data for use by the second system;
receiving processed data from the second business process through the at least one interface; and
using the processed data in the first business process.
